(19) United States
(12) Patent Application Publication
(10) Pub. No.: US 2009/0122954 A1
(43) Pub. Date: May 14, 2009

(54) Method for the extrapolation of truncated, incomplete projections for computed tomography

(76) Inventor: Herbert Bruder, Hochstadt (DE)

Correspondence Address: HARNESS, DICKEY & PIERCE, P.L.C., P.O.BOX 8910, RESTON, VA, 20195, US

(21) Appl. No.: 12/289,938

(22) Filed: Nov. 7, 2008

(30) Foreign Application Priority Data
Nov. 13, 2007 (DE) 10 2007 054 031.2

(51) Int. Cl. H05G 1/60; G06K 9/00

(52) U.S. Cl. 378/14; 382/132

(57) ABSTRACT

At least one embodiment of the present invention relates to a method for extrapolation of truncated, incomplete projections for computed tomography. At least one embodiment of the method is based on the use of CT units having multi-row detectors and scanning in spiral scan operation and includes at least the following. Firstly, scanning of an examination object with the aid of a beam. Secondly, detection of complete and incomplete projection data during a scan. Thirdly, the carrying out of a parallel rebinning for the detected projection data. Fourthly, determining incomplete, truncated projections based on analysis of the 3D signal path in the 3D sinogram belonging to each voxel in the object region. Fifthly, extrapolating the incomplete, truncated projections by continuing the terminated or discontinuous 3D signal paths according to

$$\hat{P} ( r , Φ , z ) = {min}_{( t , θ )} ( {P}_{θ} ( t ( r , θ , Φ ) , q ( z , θ ) ) \cdot {I}_{θ} ( t ) , \\ I ( t ) = \{ \begin{matrix}1 & ∀ t = r \cdot cos ( θ + Φ ) , q = q ( θ , z ) \\ 0 & otherwise\end{matrix} .$$

### PRIORITY STATEMENT

The present application hereby claims priority under 35 U.S.C. §119 on German patent application number DE 10 2007 054 031.2 filed Nov. 13, 2007, the entire contents of which is hereby incorporated herein by reference.

### FIELD

Embodiments of the present invention generally relate to a method for the extrapolation of truncated, incomplete projections for computed tomography. At least one embodiment of the method is based on the use of CT units having multi-row detectors and scanning in spiral scan operation.

### BACKGROUND

Computed tomography is known as a two-stage imaging method. In this case, an examination object is transirradiated with X-rays, and the attenuation of the X-rays is detected along the path from the radiation source (X-ray source) to the detector system (X-ray detector). The attenuation is caused by the transirradiated materials along the beam path, and so the attenuation can also be understood as the line integral over the attenuation coefficients of all the volume elements (voxels) along the beam path. Detected projection data cannot be interpreted directly, that is to say they do not produce an image of the transirradiated layer of the examination object. It is only in a second step that it is possible via a reconstruction method to calculate back from the projected attenuation data to the attenuation coefficients μ of the individual voxels, and thus to generate an image of the distribution of the attenuation coefficients. This enables a substantially more sensitive examination of the examination object than in the case of simple reviewing projection images.

Instead of the attenuation coefficient μ, in order to display the attenuation distribution use is generally made of a value normalized to the attenuation coefficient of water, this will be called CT number. This is calculated from an attenuation coefficient μ currently determined by measurement, the following equation being used:

$$C = 1000 * \frac{μ - {μ}_{{H}_{2} O}}{{μ}_{{H}_{2} O}} [ H U ] ,$$

with the CT number C in the Hounsfield unit [HU]. A value of C_{H}_{₂}_{O}=0 HU is yielded for water, and a value of C_{L}=−1000 HU is yielded for air. Since the two representations can be transformed into one another or an equivalent, the generally selected term of attenuation value or attenuation coefficient denotes both the attenuation coefficient μ and the CT value.

Modern X-ray computed tomography units (CT units) are used for recording, evaluating and displaying the three-dimensional attenuation distribution. Typically, a CT unit comprises a radiation source that directs a collimated, pyramidal or fan-shaped beam through the examination object, for example a patient, on to a detector system constructed from a number of detector elements. Depending on the design of the CT unit, the radiation source and the detector system are fitted, for example, on a gantry or a C-arm that can be rotated about a system axis (z-axis) by an angle α. Also provided is a support device for the examination object that can be displaced or moved along the system axis (z-axis).

During the recording, each detector element of the detector system that is struck by the radiation produces a signal which constitutes a measure of the total transparency of the examination object for the radiation emanating from the radiation source on its way to the detector system or the corresponding radiation attenuation. The set of output signals of the detector elements of the detector system that is obtained for a specific position of the radiation source is denoted as projection. The position emanating from which the beam penetrates the examination object is continuously varied as a consequence of the rotation of the gantry/C-arm. In this case, a scan comprises a multiplicity of projections that are obtained at various positions of the gantry/C-arm, and/or the various positions of the support device. A distinction is made here between sequential scanning methods (axial scan operation) and spiral scan methods.

As specified above, a two-dimensional slice image of a layer of the examination object is reconstructed on the basis of the data record generated in the scan. The quantity and quality of the measured data detected during a scan depend on the detector system used. A number of layers can be recorded simultaneously with the aid of a detector system that comprises an array composed of a number of rows and columns of detector elements. Detector systems with 256 or more rows are currently known.

Problems in the reconstruction of the projection data arise whenever the geometry of the examination object projects beyond the detector measurement field for at least some projection angles during the above-described detection of the projection data. In these cases, the projection data detected in the transirradiation of the examination object are truncated, that is to say incomplete, and this leads to image artifacts in the reconstruction. In order, nevertheless, to enable as accurate as possible an image reconstruction, there is a need for appropriate extrapolations before the reconstruction for the truncated, incomplete projections.

### SUMMARY

In at least one embodiment of the invention, a method is specified for the extrapolation of truncated, incomplete projections for computed tomography.

### BRIEF DESCRIPTION OF THE DRAWINGS

Further advantages, features and properties of the present invention are explained below in more detail with the aid of exemplary example embodiments and with reference to the accompanying drawings, in which:

FIG. 1 discloses an example embodiment of the present invention.

FIG. 2 is schematic of a section through an examination object 1 in the plane of rotation of the focus F (z=constant).

A projection in parallel beam geometry is illustrated in FIG. 3.

FIG. 4 shows in its left-hand image a 3D sinogram in parallel coordinates (θ, t, q).

In FIG. 5, signal paths for voxels outside of the field of view are illustrated as a 2D sinogram for the purposes of simplification.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled, ” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a, ” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region layer, or section. Thus, a first element, component, region, layer, or section discussed below could be termed a second element, component, region, layer, or section without departing from the teachings of the present invention.

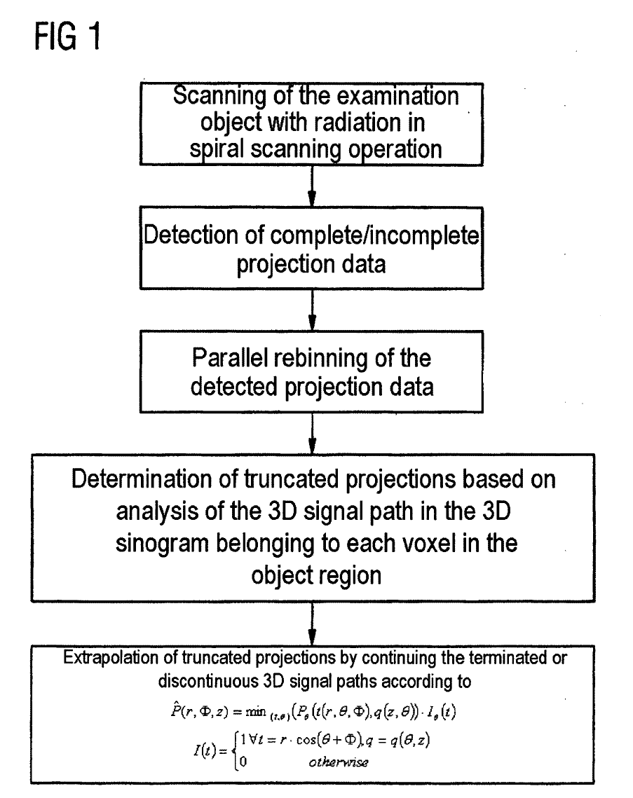

In an embodiment of the invention, the inventive method for the extrapolation of truncated, incomplete projections for computed tomography has at least the following five method steps (compare FIG. 1).

Firstly, scanning an examination object arranged in the object region using an imaging system with the aid of at least one conical beam emanating from a focus and having an aperture angle (2β₀), and of a detector array with detector elements, arranged in a number of detector rows and a number of detector columns, for detecting the beam, in which case the at least one focus is guided relative to the examination object on a focal path running spirally around the examination object along a system axis (Z-axis), the detector elements of the detector array supply projection data that represent the attenuation of the rays upon passage through the object region, and a region for all focal positions lying within boundary rays of the encircling beam defines a field of view of the imaging system.

Secondly, during a scan, detection of complete projections in the case of which a lateral extent of the examination object is completely imaged on the detector array by the beam, and of incomplete, truncated projections in the case of which the lateral extent of the examination object is imaged incompletely on the detector array by the beam. In this case, a scan refers to the detection of projections for a number of focal positions, that is to say typically at least one 180° rotation of the focus.

Thirdly, parallel rebinning of the detected projections by resorting and conversion of the projection data P(α, β, q) present in fan geometry into projection data P(θ, t, q) present in parallel geometry, in which case all the projection data P(θ, t, q) represent a 3D sinogram, and one voxel (r, Φ, z) in the object region defines exactly one 3D signal path S(θ, t, q) in the 3D sinogram, with:

$$t ( r , θ , Φ ) = r \cdot cos ( θ + Φ ) , y ( r , θ , Φ ) = r \cdot sin ( θ + Φ ) , \\ q ( θ , r ) = [ z - \frac{{z}_{rot} \cdot ( θ - arcsin ( \frac{t}{{R}_{f}} ) / 2 π ) )}{tan ( {δ}_{cone} ) \cdot R \cdot \sqrt{1 - {( \frac{t}{{R}_{f}} )}^{2} + y}} ] ,$$

where
α is the focus angle,
β is the fan angle,
q is the row index of the detector array corresponding to the z-coordinate,
θ=α+β is the parallel fan angle,
t=R_{F}*sin(β) is the parallel coordinate corresponding to the beam spacing from the axis of rotation (system axis),
R_{F} is the radius of the focal path,
Zᵣₒₜ is the z-feed of the focus per revolution in spiral operation,
r, Φ, z are cylindrical coordinates of a voxel in the object region, and
δ_{cone} is the cone opening angle of half of the detector.
   Moreover, it holds for the z-coordinate of a layer q of a parallel projection in parallel geometry with reference to a detector center that

$$z = ( q - \frac{{N}_{q}}{2} ) \cdot S + η ; {S}^{->} = S \cdot \sqrt{1 - {( \frac{t}{{R}_{f}} )}^{2}} ; η = {z}_{rot} \cdot arcsin ( \frac{t}{{R}_{f}} ) / ( 2 π ) ,$$

where zᵣₒₜ is the z-feed per revolution in spiral operation, and N_{q} is the number of detector rows.

In the following, the geometric conditions while the projection data is recorded are clarified in the simplified, two-dimensional case (z=constant). It may be assumed here that during recording of the projections the examination object projects over the field of view (FOV)—still to be defined below—of the CT unit.

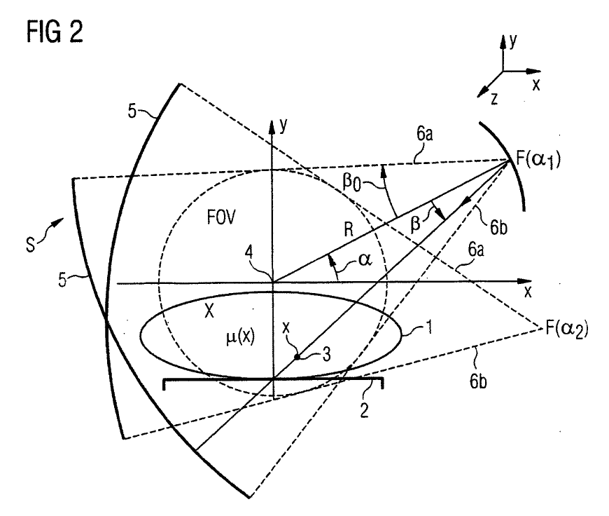

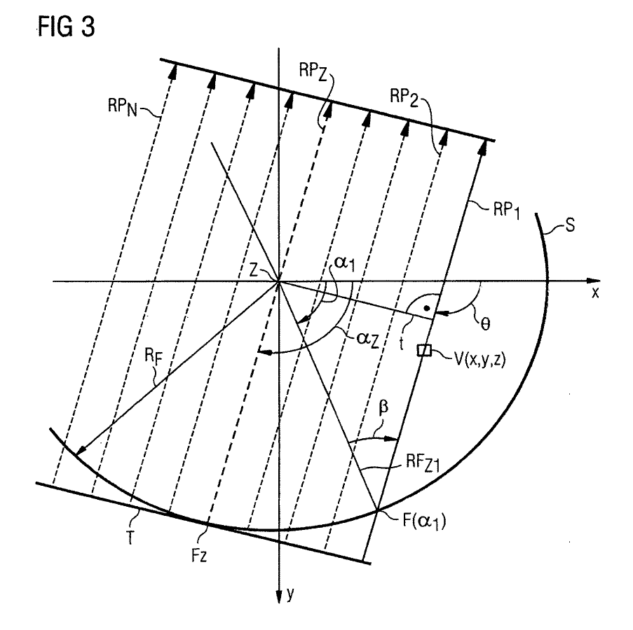

FIG. 2 is schematic of a section through an examination object 1 in the plane of rotation of the focus F (z=constant). The basic Cartesian coordinate system is formed by the x- and y-axes lying in the plane of the image, and by the z-axis, which is perpendicular to the plane of the image and corresponds to the axis of symmetry 4 of the CT unit. Arranged situated opposite the focus F that can rotate about the axis of symmetry 4 is a single-row detector array 5 that also rotates with the focus F. Emanating from the focus F is a beam with an aperture angle 2β₀ that strikes the detector array 5. The beam is bounded by the outer marginal rays 6a and 6b. The region that lies for all focal positions F(α₁) between the marginal rays 6a and 6b is denoted as the “field of view” of the CT unit. The region outside the field of view is denoted as “extended field of view”.

Moreover, the geometric conditions regarding the projection of the examination object 1 for two different focal positions F(α₁) and F(α₂) can be gathered from FIG. 2. In both cases, in addition to the focal positions the beams emanating from the focus are each specified by their marginal rays 6a and 6b, and the associated detector positions are specified. It is clearly to be seen that for the focal position F(α₂) the entire circumferential line of the cross section of the examination object is detected by the projection, and thus that a complete projection of the examination object 1 is generated, as in the focal position F(α₁) the right hand part of the examination object projects over the beam, or the detector array, the result being a truncated, incomplete projection of the examination object 1.

In the present case, both complete and truncated, incomplete projections are detected during scanning of the examination object in spiral scanning operation. The projection data obtained in this case are firstly present in fan beam geometry in the form of rays P(α, β, q). Here, α corresponds to the focal angle, β to the fan angle and q to the row index of the detector system that corresponds to the z-coordinate.

In the third method step, the projection data detected in fan beam geometry during scanning of the examination objects are therefore converted into data in parallel beam geometry in a way known per se by a method denoted in general as rebinning. This conversion is based on a resorting of the projection data obtained in fan beam geometry in such a way that beams are extracted from different projections recorded in fan beam geometry and combined to form a projection in parallel geometry. In parallel beam geometry, data from one interval of length Π suffice to be able to reconstruct a complete image. In order to obtain these data, it is necessary nevertheless for data in fan beam geometry to be available for an interval of length of Π+2β₀.

A projection in parallel beam geometry is illustrated in FIG. 3. According to this, all n parallel beams RP1 to RPN of this projection adopt the parallel angle θ to the x-axis of the coordinate system illustrated in FIG. 3 and corresponding to that in accordance with FIG. 2.

The aim below is to use the parallel beam RP₁ illustrated by a continuous line in FIG. 3 in order to explain the transition from fan beam geometry to parallel beam geometry. The parallel beam RP₁ stems from the projection obtained in fan beam geometry for the focal position F(α₁) lying on the focal paths. The central beam RF_{z1} belonging to this projection in fan beam geometry and running through the z-axis of the coordinate system is likewise plotted in FIG. 3. The focal position F(α₁) corresponds to the focal angle α₁. This is the angle enclosed by the x-axis and the central beam RF_{z1}. The beam RP₁ has the fan angle β in comparison to the central beam RF_{z1}. It is therefore easy to recognize that θ=α+holds β for the parallel fan angle θ. The beam spacing t, measured at right angles to the respective parallel beam, from the z-axis is given by t=R_{f}*sin(β). As becomes clear with the aid of the central beam RP_{z} that is represented by a bold line in FIG. 3 and runs through the z-axis and/or the x-axis, this beam is the central beam of a projection in fan beam geometry that is recorded in fan geometry for the focal position F_{z} at the focal angle α_{z}. Since it holds that β=0 for the central beam of a projection recorded in fan beam geometry, it is made clear that the following holds for the case of central beams: depending on whether an azimuthal or complete rebinning is carried out, the parallel projections are present in the form P(α, β, q) or in the form P(θ, t, q). At the end of third method step, that is to say after the rebinning of the measured projection data, the projection data are present as a three-dimensional parallel sonogram P(θ, t, q).

In this 3D sinogram, exactly one 3D signal path S(θ, t, q) in the 3D sinogram is assigned to each voxel (r, Φ, z) in the object region, that is to say in that space in which the examination object is arranged. This 3D signal path is determined by:

$$\begin{matrix}t ( r , θ , Φ ) = r \cdot cos ( θ + Φ ) , & ( 1 ) \\ q ( θ , r ) = [ z - \frac{{z}_{rot} \cdot ( θ - arcsin ( \frac{t}{{R}_{f}} ) / 2 π ) )}{tan ( {δ}_{cone} ) \cdot R \cdot \sqrt{1 - {( \frac{t}{{R}_{f}} )}^{2} + y}} ] \\ with y ( r , θ , Φ ) = r \cdot sin ( θ + Φ ) , & ( 2 )\end{matrix}$$

where
q is the row index of the detector array corresponding to the z-coordinate,
θ=α+β is the parallel fan angle,
t is the parallel coordinate corresponding to the beam spacing from the axis of rotation (system axis),
zᵣₒₜ is the z-feed of the focus per revolution in spiral operation,
r, Φ, z are cylindrical coordinates of a voxel in the object region, and
δ_{cone} is the cone opening angle of half of the detector.

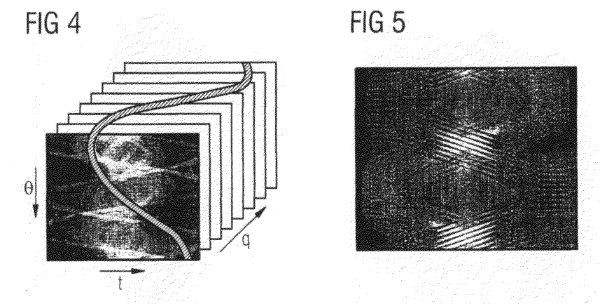

In order to visualize the preceding discussion, FIG. 4 shows in its left-hand image a 3D sinogram in parallel coordinates (θ, t, q). In spiral operation, each voxel defines a 3D signal path in this sinogram. One such 3D signal path is illustrated in a highlighted fashion as a thick black line. In the right-hand image of FIG. 5, signal paths for voxels outside of the field of view are illustrated as a 2D sinogram for the purposes of simplification.

In the fourth method step, incomplete, truncated projections are determined based on analysis of the 3D signal path in the 3D sinogram belonging to each voxel in the object region, with voxels in the object region lying outside of the field of view being respectively imaged in the 3D sinogram as terminated or discontinuous 3D signal paths.

In the fifth method step, the incomplete, truncated projections are extrapolated by continuing the terminated or discontinuous 3D signal paths according to

$$\begin{matrix}\hat{P} ( r , Φ , z ) = {min}_{( t , θ )} ( {P}_{θ} ( t ( r , θ , Φ ) , q ( z , θ ) ) \cdot {I}_{θ} ( t ) , & ( 3 ) \\ I ( t ) = \{ \begin{matrix}1 & ∀ t = r \cdot cos ( θ + Φ ) , q = q ( θ , z ) \\ 0 & otherwise\end{matrix} & ( 4 )\end{matrix}$$

where \hat{P}(r,Φ,z) is the continued 3D signal path of a voxel (r, Φ, z) lying outside of the field of view, and min_{(t,θ)}(P_{θ}(t(r,θ,Φ),q(z,θ))·I_{θ}(t) is a minimum found for this voxel along the 3D signal path within the field of view.

The basic idea of the method according to at least one embodiment of the invention is thus based on following the 3D signal path for each voxel of the three-dimensional object region in the corresponding 3D sinogram after recording projection data in the object region using a multi-row CT unit in spiral scanning operation, and appropriately extrapolating the truncated projections. If voxels outside of the field of view are considered in the process, then the projection data is truncated and the 3D signal path is continued according to the invention using equations (3) and (4). In the process, the minimum found along the 3D signal path within the field of view is entered into the continuation of the 3D signal path outside of the field of view, that is to say in the so-called “extended field of view”. The idea on which this is based is that a δ-object in the voxel (r, Φ, z) would generate precisely this signal in the 3D sinogram.

In the case of 3D signal paths crossing, the sum of the signals of the individual paths is entered into the corresponding detector pixels.

In an advantageous refinement of at least one embodiment of the method, signal levels of the continued 3D signal path are matched at the boundary of the field of view to remove discontinuities. By way of example, this can be effected by determining in a 3D signal path the signal levels in a partial region within and outside of the field of view by forming an average and removing discontinuities on the edge of the field of view by appropriate scaling of the projection data. Mixing a minimum signal and the actual signal within a path at the edge of the field of view is also helpful in removing discontinuities.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for extrapolating truncated, incomplete projections for computed tomography, the method comprising:
scanning an examination object, arranged in an object region of an imaging system, using at least one conical beam emanating from a focus and having an aperture angle, and using a detector array with detector elements, arranged in a number of detector rows and a number of detector columns, to detect the at least one beam, wherein
the at least one focus is adapted to be guided relative to the examination object on a focal path running spirally around the examination object along a system axis,
the detector elements of the detector array are adapted to supply projection data that represent the attenuation of the rays upon passage through the object region, and
a region for all focal positions lying within boundary rays of the encircling beam defines a field of view of the imaging system;
during a scan, detecting complete projections upon a lateral extent of the examination object is completely imaged on the detector array by the beam, and detecting incomplete, truncated projections upon the lateral extent of the examination object is imaged incompletely on the detector array by the beam;
parallelly rebinning the detected at least one of complete and incomplete projections by researching and converting the projection data P(α, β, q) present in fan geometry into projection data P(θ, t, q) present in parallel geometry, wherein
all the projection data P(θ, t, q) represent a 3D sinogram, and one voxel (r, Φ, z) in the object region defines exactly one 3D signal path S(θ, t, q) in the 3D sinogram, with:
$$t ( r , θ , Φ ) = r \cdot cos ( θ + Φ ) , y ( r , θ , Φ ) = r \cdot sin ( θ + Φ ) , \\ q ( θ , r ) = [ z - \frac{{z}_{rot} \cdot ( θ - arcsin ( \frac{t}{{R}_{f}} ) / 2 π ) )}{tan ( {δ}_{cone} ) \cdot R \cdot \sqrt{1 - {( \frac{t}{{R}_{f}} )}^{2} + y}} ] ,$$
where
α is the focus angle,
β is the fan angle,
q is the row index of the detector array corresponding to the z-coordinate,
θ=α+β is the parallel fan angle,
t=R_{F}*sin(β) is the parallel coordinate corresponding to the beam spacing from the axis of rotation (system axis),
R_{F} is the radius of the focal path,
zᵣₒₜ is the z-feed of the focus per revolution in spiral operation,
r, Φ, z are cylindrical coordinates of a voxel in the object region, and
δ_{cone} is the cone opening angle of half of the detector;
determining incomplete, truncated projections based on analysis of the 3D signal path in the 3D sinogram belonging to each voxel in the object region, with voxels in the object region lying outside of the field of view being respectively imaged in the 3D sinogram as terminated or discontinuous 3D signal paths; and
extrapolating the incomplete, truncated projections by continuing the terminated or discontinuous 3D signal paths according to
$$\begin{matrix}\hat{P} ( r , Φ , z ) = {min}_{( t , θ )} ( {P}_{θ} ( t ( r , θ , Φ ) , q ( z , θ ) ) \cdot {I}_{θ} ( t ) , \\ I ( t ) = \{ \begin{matrix}1 & ∀ t = r \cdot cos ( θ + Φ ) , q = q ( θ , z ) \\ 0 & otherwise\end{matrix}\end{matrix}$$
where
\hat{P}(r,Φ,z) is the continued 3D signal path of a voxel (r, Φ, z) lying outside of the field of view, and
min_{(t,θ)}(P_{θ}(t(r,θ,Φ),q(z,θ))·I_{θ}(t) is a minimum found for this voxel along the path within the field of view.

2. The method as claimed in claim 1, wherein signal levels of the continued 3D signal path are matched at the boundary of the field of view to remove discontinuities.

3. The method as claimed in claim 2, wherein the adaptation comprises forming an average in partial regions of the 3D signal path within and outside of the field of view, and scaling of the projection data.

4. The method as claimed in claim 2, wherein the adaptation comprises averaging the minimum found along the path within the field of view and the value measured at the edge of the field of view.

5. A computer readable medium including program segments for, when executed on a computer device, causing the computer device to implement the method of claim 1.
